(19) United States
(12) Patent Application Publication
(10) Pub. No.: US 2018/0290178 A1
(43) Pub. Date: Oct. 11, 2018

(54) CLEANING SYSTEM FOR TOILET PLUNGER

(71) Applicant: Barry LEVITT, (US)

(72) Inventors: Barry LEVITT, Atlanta, GA (US); Paul DOWD, Scarsdale, NY (US); Bennet POEPPING, Tuckahoe, NY (US); Joshua PELTON, New Rochelle, NY (US)

(73) Assignee: Barry LEVITT, Atlanta, GA (US)

(21) Appl. No.: 15/945,909

(22) Filed: Apr. 5, 2018

Related U.S. Application Data
(60) Provisional application No. 62/482,386, filed on Apr. 6, 2017.

(51) Int. Cl. B08B 3/02

(52) U.S. Cl. CPC B08B 3/02; E03C 1/308

(57) ABSTRACT

A cleaning system for a toilet plunger includes an open/close shell assembly, an open/close actuating assembly, a cleaner dispersing assembly, a cleaner pump assembly, and a cleaner reservoir assembly, configured for providing a two-stage sequential operation to close the shell assembly upon resting the plunger on a plunger support and then to spray a cleaner onto the plunger upon applying an addition force to the plunger. The shell assembly is reconfigurable between open and closed positions by operation of the actuating assembly such that, upon placing the plunger on the plunger support, the weight of the plunger activates the actuating assembly to move the shell assembly to the closed position. And then applying the additional force to the plunger activates the cleaner pump assembly to deliver the cleaner from the cleaner reservoir assembly to the cleaner dispersing assembly and onto the plunger in the closed shell assembly.

### CROSS REFERENCE TO RELATED APPLICATION

The present application claims the priority benefit of U.S. Provisional Patent Application Ser. No. 62/482,386, filed Apr. 6, 2017, which is hereby incorporated herein by reference.

### TECHNICAL FIELD

The present invention relates generally to toilet plungers for unclogging toilets, and particularly to systems for cleaning and storing such toilet plungers.

### BACKGROUND

The toilet plunger is a common household tool that is found in millions of homes throughout the world. Anyone that has used a plunger to unclog a toilet is aware of the problems with cleaning them after such use. The plunger is now wet and unsanitary, and carrying or placing it somewhere within the home, even on the bathroom floor, is quite repulsive to many people. Common techniques for sanitizing a plunger include pouring bleach over it in the toilet or bath, or taking it outside to “hose down.” Other approaches include not actually sanitizing the plunger after use, but giving it a gentle whisk in the toilet after unclogging and flushing, then storing it in a bag or bucket beside the toilet until its next use. None of these techniques have proven very satisfactory.

Accordingly, it can be seen that there exists a need for a way to clean toilet plungers in a quick, easy, and unmessy way. It is to the provision of solutions to this and other problems that the present invention is primarily directed.

### SUMMARY

Generally described, the present invention relates to a cleaning system for a toilet plunger and includes an open/close shell assembly, an open/close actuating assembly, a cleaner dispersing assembly, a cleaner pump assembly, and a cleaner reservoir assembly. These components are configured for providing a two-stage sequential operation to first close the shell assembly upon resting the plunger on a plunger support of the device and then to spray a cleaner onto the plunger upon applying an addition force to the plunger. The shell assembly is reconfigurable between open and closed positions by operation of the actuating assembly such that upon placing the plunger on the plunger support with the shell assembly in the open position, the weight of the plunger activates the actuating assembly to move the shell assembly to the closed position. And then applying the additional force to the plunger activates the cleaner pump assembly to deliver the cleaner fluid from the cleaner reservoir assembly through the cleaner dispersing assembly and onto the plunger in the closed shell assembly.

The specific techniques and structures employed to improve over the drawbacks of the prior devices and accomplish the advantages described herein will become apparent from the following detailed description of example embodiments and the appended drawings and claims.

### BRIEF DESCRIPTION OF THE DRAWINGS

FIG. 1 is a front side view of a plunger-cleaning system according to a first example embodiment of the invention.

FIG. 2 is a front side cross-sectional view of the plunger-cleaning system of FIG. 1, with a shell assembly in a closed position and a cleaner pump assembly in a neutral position, and with some internal components excluded to better-show other internal components of the system.

FIG. 3 is a left side cross-sectional view of the plunger-cleaning system of FIG. 1, with the shell assembly in the closed position and the cleaner pump assembly in the neutral position, and with some internal components excluded to better-show other internal components of the system.

FIG. 4 is a left-front side cross-sectional view of the plunger-cleaning system of FIG. 1, with a shell assembly in an open position and the cleaner pump assembly in the neutral position, and with some internal components excluded to better-show other internal components of the system.

FIG. 5 is a left side view of the plunger-cleaning system of FIG. 1, with the shell assembly in the open position and the cleaner pump assembly in the neutral position, and with the base cover removed and the cleaner pump and dispersing assemblies excluded to show details of the open/close actuating assembly.

FIG. 6 shows the plunger-cleaning system of FIG. 5 with the shell assembly in the closed position and the cleaner pump assembly in an actuated/spray position.

FIG. 7 shows a detail portion of the plunger-cleaning system of FIG. 3 with the shell assembly and the open/close actuating assembly in the open/raised position.

FIG. 8 shows the plunger-cleaning system detail portion of FIG. 7 with the shell assembly and the open/close actuating assembly moving toward the closed/lowered position.

FIG. 9 shows the plunger-cleaning system of FIG. 3, with the shell assembly in the closed position (as in FIG. 3) and the cleaner pump assembly in the actuated/spray position (in contrast to FIG. 3) to pump cleaner into the closed shell assembly, and with some internal components excluded to better-show other internal components of the system.

FIG. 10 shows a detail/portion of the plunger-cleaning system of FIG. 9, with the cleaner pump assembly in a neutral position corresponding to FIG. 3.

FIG. 11 shows the plunger-cleaning system detail/portion of FIG. 10, with the pump assembly in the process of being actuated and disengaging a valve locking mechanism.

FIG. 12 shows the plunger-cleaning system detail/portion of FIG. 11, with the pump assembly being further actuated and the lock disengaged.

FIG. 13 shows the plunger-cleaning system detail/portion of FIG. 12, with the pump assembly being fully actuated to operate the spray valve to dispense the cleaner into the closed shell assembly.

FIG. 14 is a right side cross-sectional view of a reservoir assembly of the plunger-cleaning system of FIG. 1.

FIG. 15 is a front side view of a cleaner pump assembly of a plunger-cleaning system according to a second example embodiment of the invention, with the cleaner pump assembly in a neutral position.

FIG. 16 shows the cleaner pump assembly of FIG. 15 with the pump assembly in the process of being actuated through a compression stroke.

FIG. 17 shows the cleaner pump assembly of FIG. 16 with the pump assembly fully actuated to spray the cleaner fluid.

FIG. 18 shows the cleaner pump assembly of FIG. 17 with the pump assembly in the process of being actuated through an expansion stroke.

### DESCRIPTION OF EXAMPLE EMBODIMENTS

The present invention relates to a cleaning system for toilet plungers. In example embodiments, the cleaning system is self-contained and can be used to both sanitize and store a toilet plunger in a simple yet effective way that requires minimal effort and avoids creating a mess. In the embodiments described herein, the plunger-cleaning system is designed for use with a flange-type toilet plunger. In other embodiments, the plunger-cleaning system is adapted for use with bell-type plungers for unclogging toilets, sinks, drains, etc. In addition, the plunger-cleaning system of the depicted embodiment is designed for use with a cleaner that is an evaporative cleaning fluid so that it leaves no or only negligible residue. For example, the cleaner can be a conventional liquid disinfectant that has an alcohol base for killing bacteria and that evaporates when exposed to air. In other embodiments, other types of liquid and/or gas cleaners can be used. The plunger-cleaning system can be provided in a kit along with a supply of the cleaner and/or a new plunger specifically configured (i.e., sized, shaped, and weighted) for it, or it can be provided by itself for use with a separately provided (e.g., existing) plunger and/or cleaner.

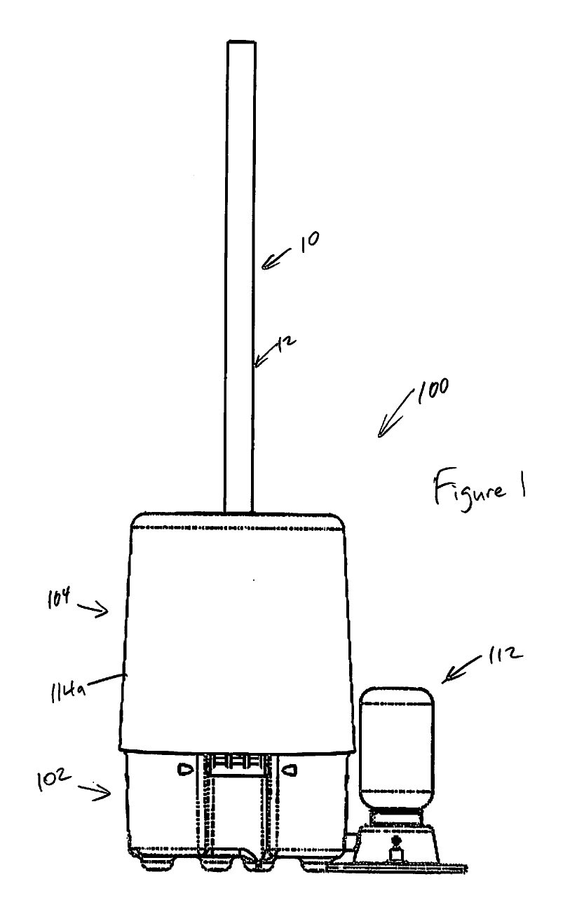

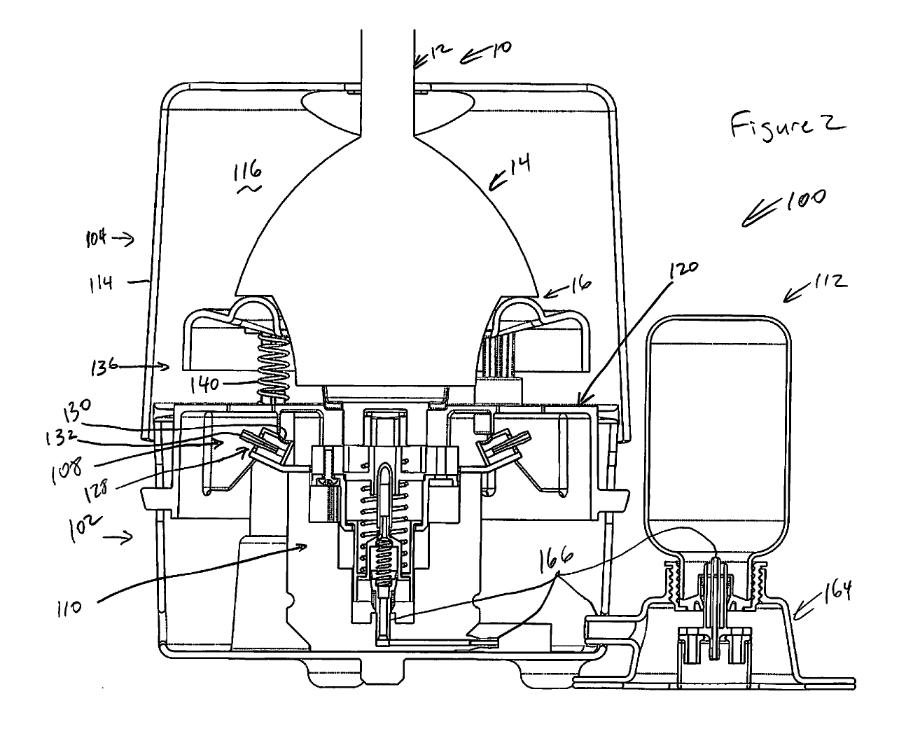

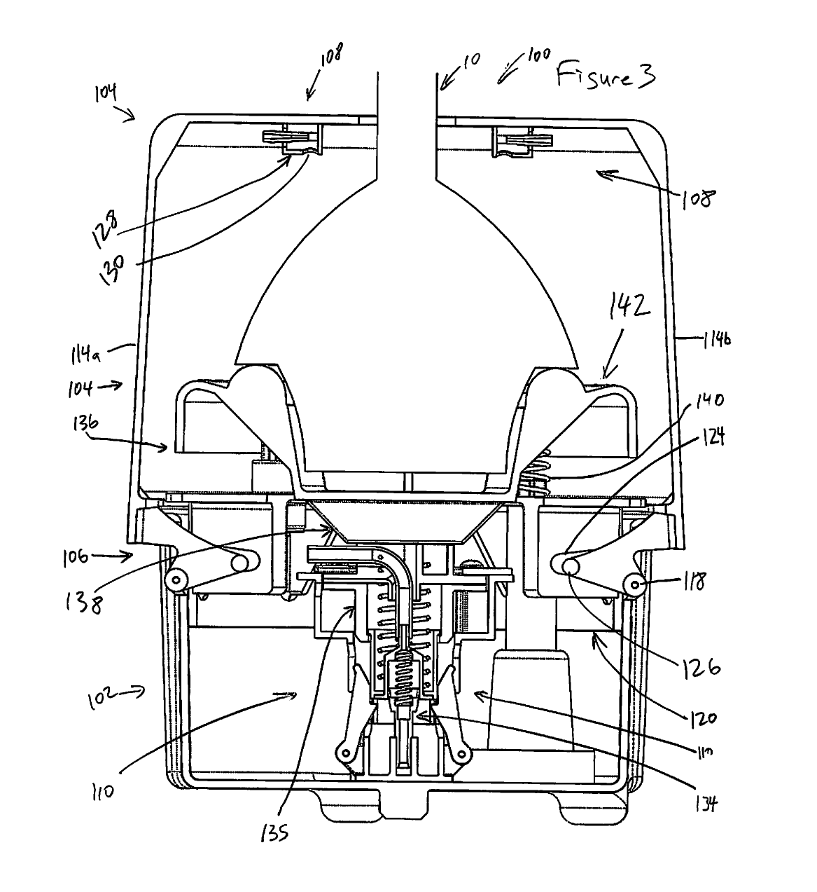

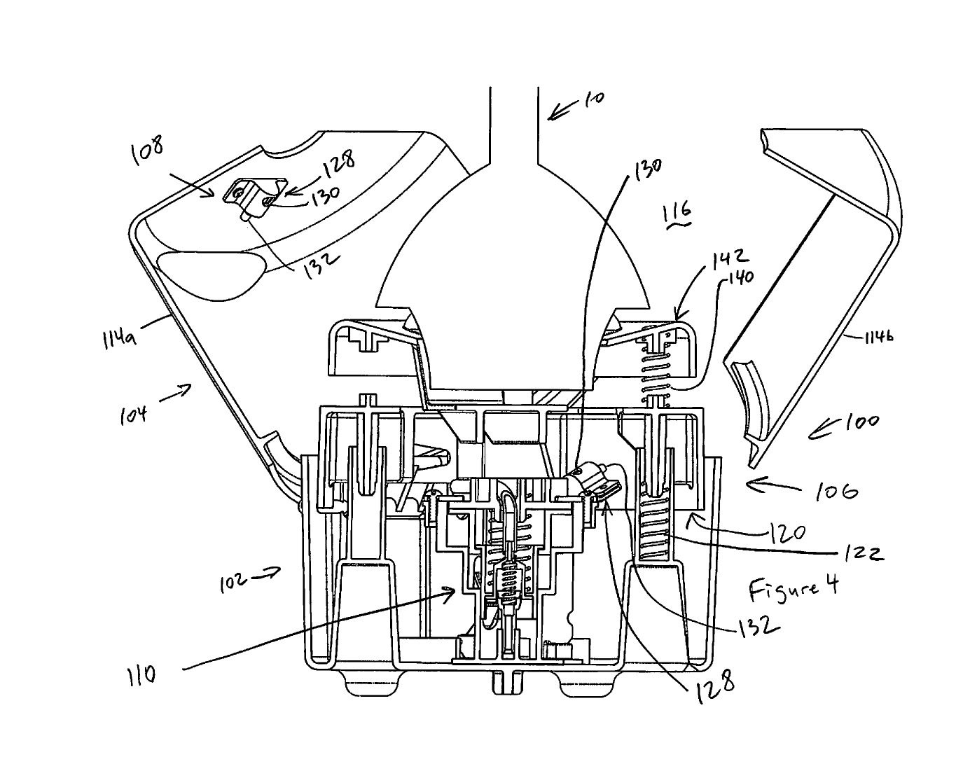

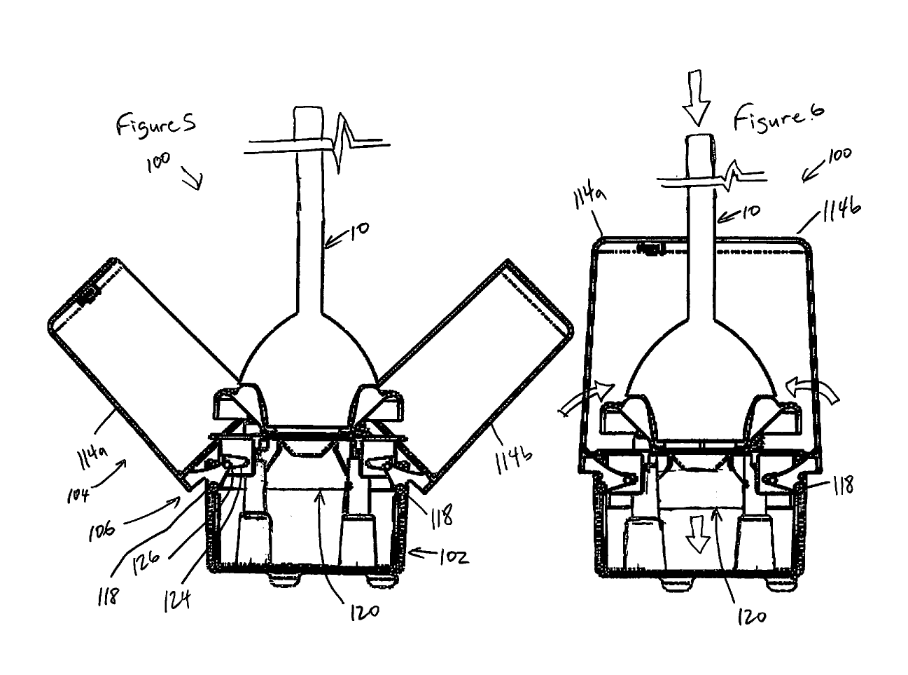

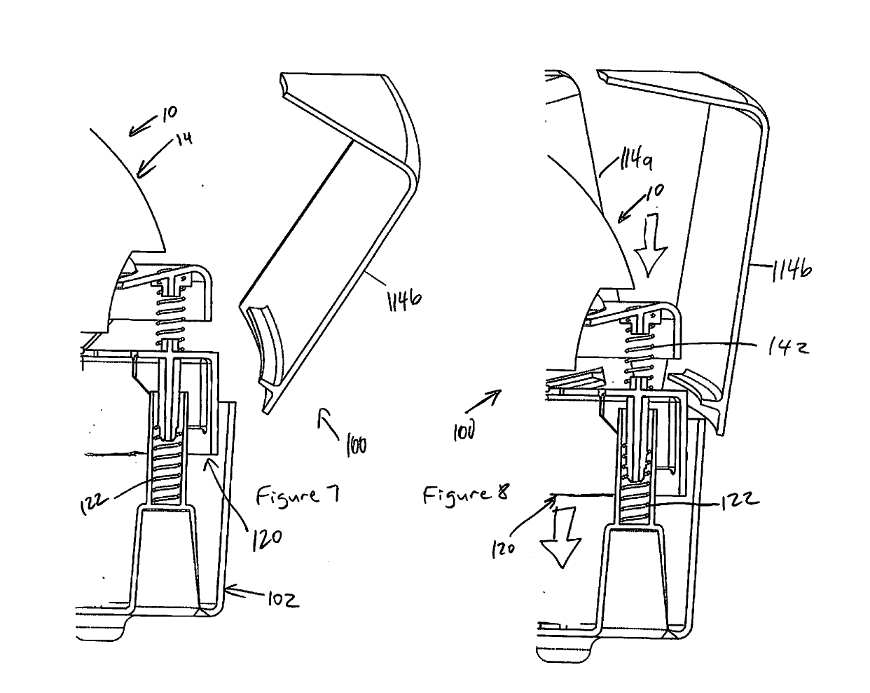

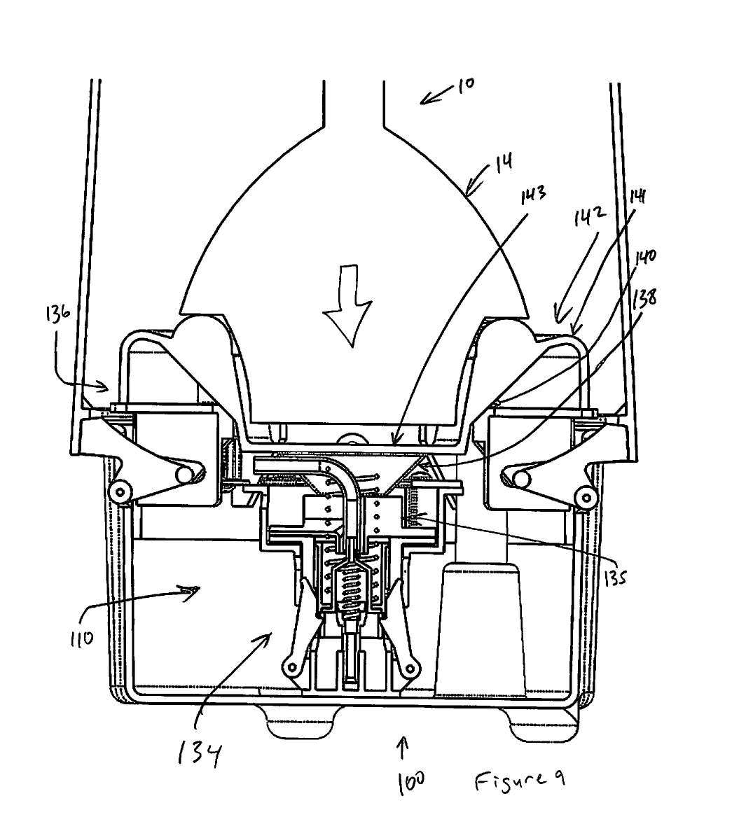

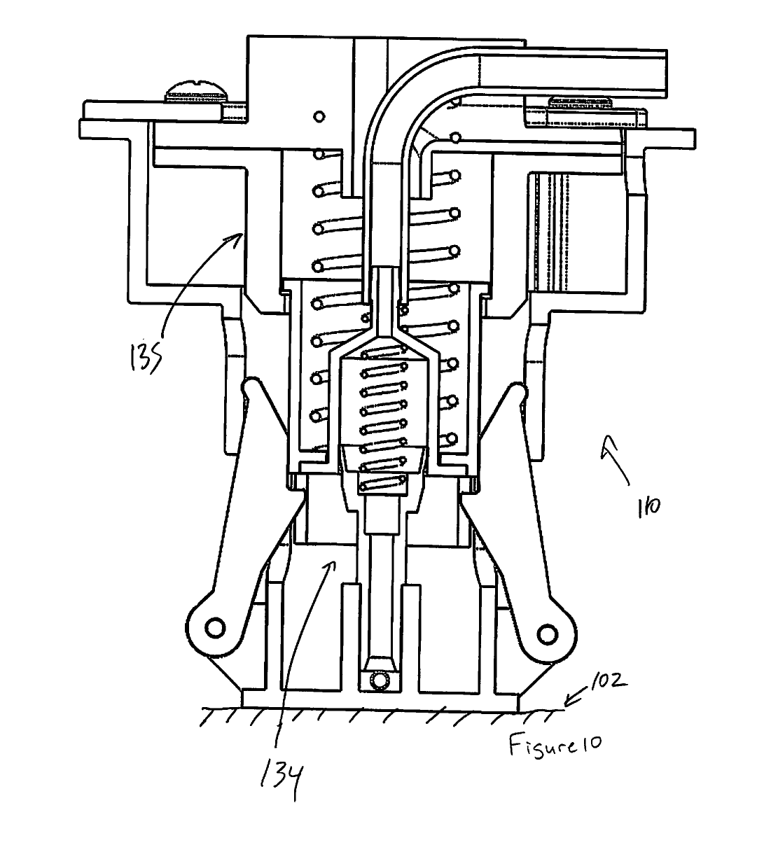

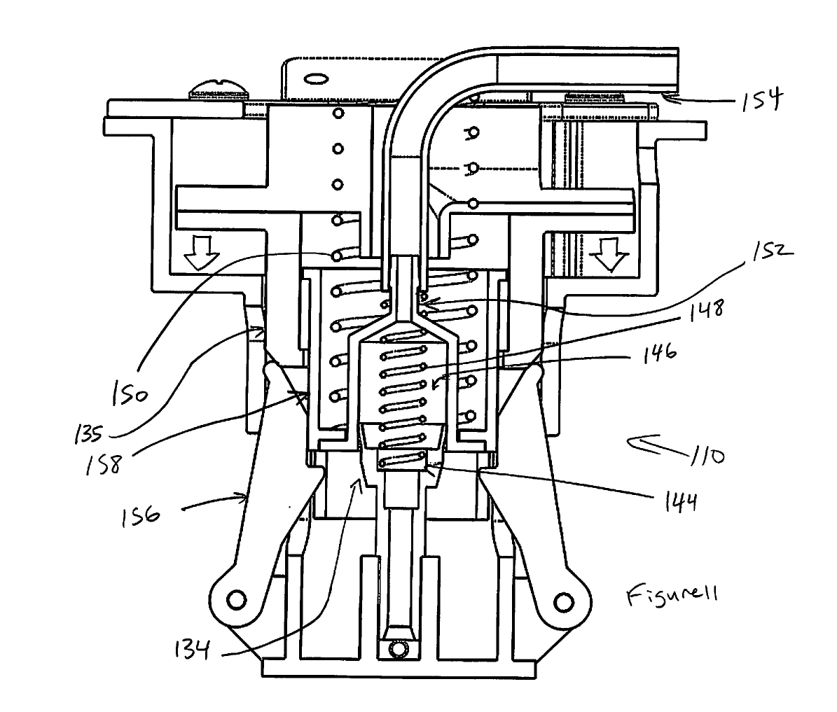

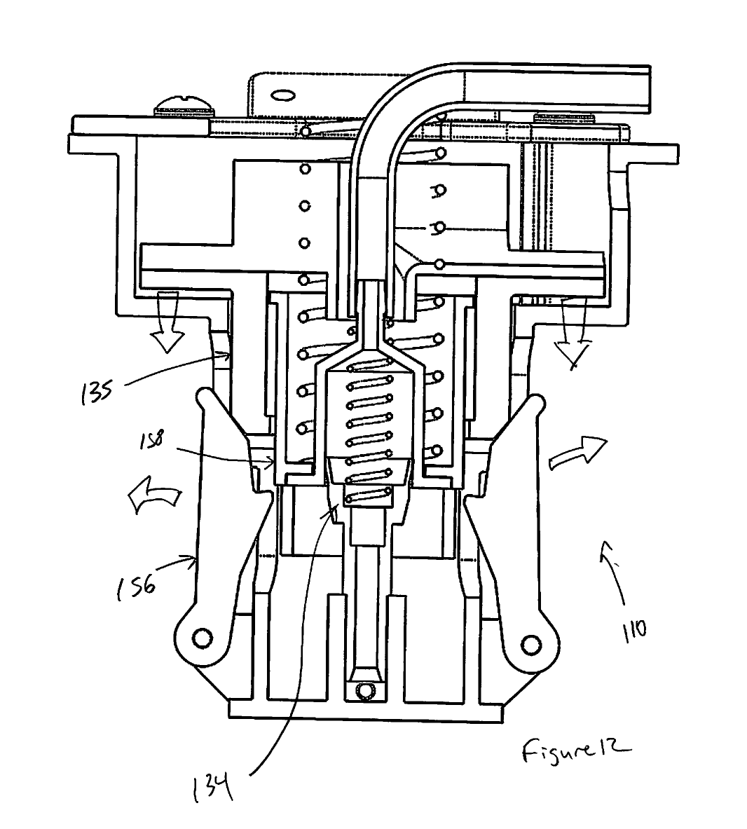

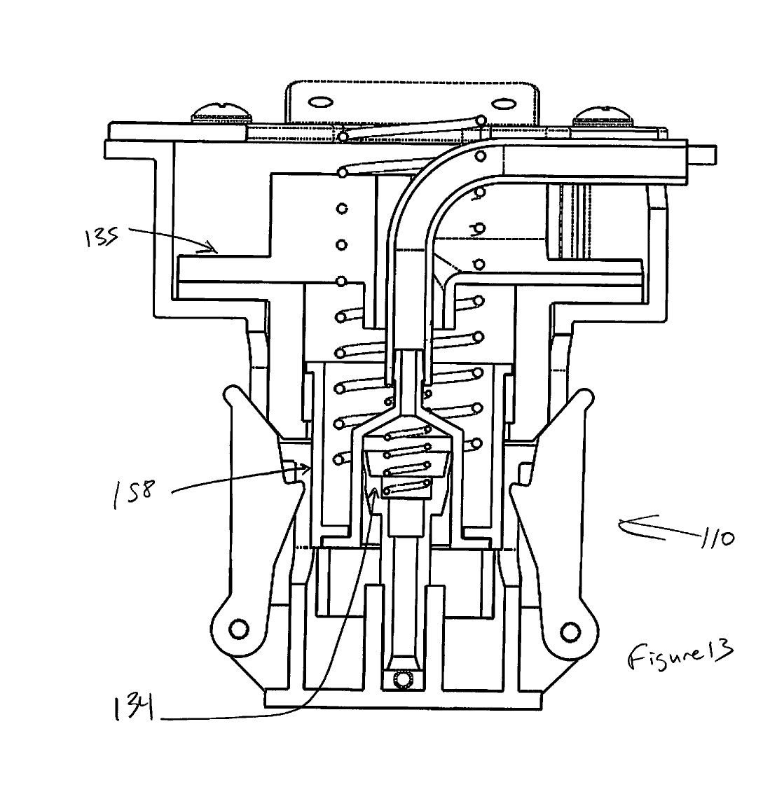

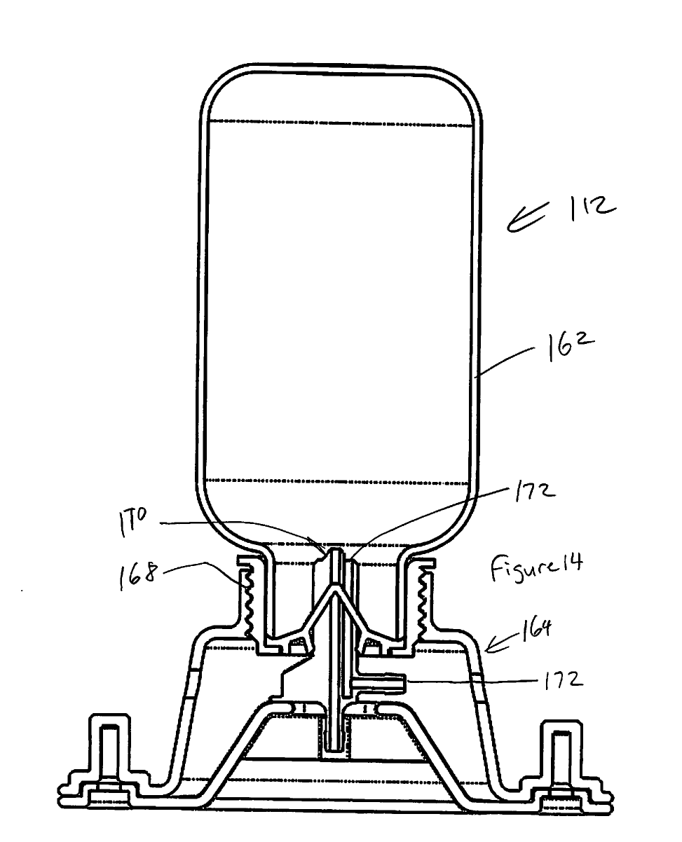

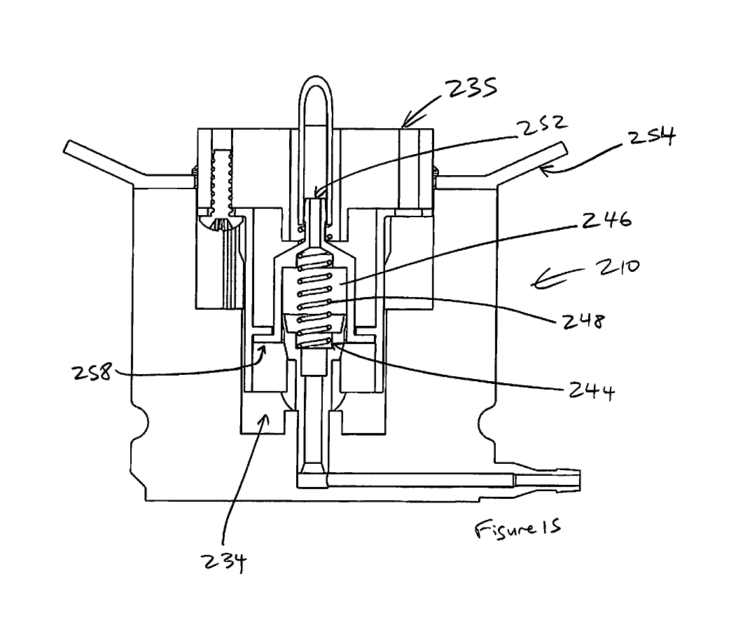

FIGS. 1-14 show a cleaning system 100 for a toilet plunger 10 according to a first example embodiment of the invention. The depicted plunger 10 is of a conventional flanged-type design and construction having a rigid shaft 12 (e.g., made of wood, metal, or plastic) and a head 14 mounted to the shaft, having a flange 16, and made of a resiliently deformable material (e.g., rubber or a rubberized material).

Referring particularly to FIGS. 1-4, the major components of the plunger-cleaning system 100 will be described. The cleaning system 100 includes a base 102, an open/close shell assembly 104, an open/close actuating assembly 106, a cleaner dispersing assembly 108, a cleaner pump assembly 110, and a cleaner reservoir assembly 112. These components can be made of conventional materials (e.g., metals and/or hard plastics) using conventional fabrication techniques (e.g., molding and/or stamping) and assembly techniques (e.g., fasteners and/or snap-fit couplings), so details of how to make the major components of the plunger-cleaning system 100 are not included for brevity.

The base 102 is configured for resting stably upon a support surface (e.g., a bathroom floor) and thus can have support feet (e.g., as depicted). The base 102 houses components of the system (e.g., the cleaner pump assembly 110) and thus typically includes a peripheral sidewall and a bottom wall defining a housing for such components.

The open/close shell assembly 104 includes plural shell portions 114a and 114b (collectively referred to as 114) with at least one of them that moves between an open position and a closed position, defines an interior space 116, and is supported by the base 102. In the depicted embodiment, there are two shell portions 114 that are pivotally mounted 118 to the base 102 at their bottoms so that they pivot open about horizontal axes at their bottoms with their tops pivoting outward and downward to form an upper access opening exposing the interior space 116 from above. With the shell portions 114 in this clamshell configuration, in the open position the plunger head 14 can be inserted into and removed from the interior space 116, and in the closed position the plunger head is enclosed within the interior space for cleaning. One or both of the shell portions 114 include an opening (e.g., the depicted notches) in communication with the interior space 116 when the shell portions are in the closed position to permit the plunger shaft 12 to extend up and out of the interior space by passing through the shell assembly.

In other embodiments, the open/close shell assembly includes plural shell portions that move in another manner between open and closed positions, for example by a swivel, rotary, helical, or linearly sliding motion, by pivoting open/close about a vertical axis instead of about horizontal axes, by one of the shell portions being a displaceable top/lid that moves (e.g., pivots) open away from the other fixed shell portion (which can be formed by a portion of the base, in which case there is only one dedicated shell portion), or by other shell/wall enclosure configurations. In the depicted embodiment, there are two of the shell portions, though in other embodiments there can be more than two shell portions.

The open/close actuating assembly 106 is operable to move the shell portions 114 between the open and closed positions. The open/close actuating assembly 106 includes a spring-biased platform 120 that moves down when the plunger 10 is placed upon it and that is coupled to the pivotal shell portions 114 to cause them to pivot closed when the plunger moves down, as best shown by additional reference to FIGS. 5-8. The platform 120 moves down under the weight of the plunger 10, so the plunger 10 can rest indirectly on the platform (e.g., with a plunger support 142 and an actuator mechanism 136 of the cleaner pump assembly 110 positioned between them) as depicted, and in other embodiments the plunger can rest directly upon and directly contact the platform.

The platform 120 is biased upward, and thus the shell portions 114 are biased open, by an open/close spring element 122. In the depicted embodiment, the spring element 122 is a coil compression spring, though in other embodiments other types of springs can be used such as tension springs, torque springs, an elastically deformable material, a fluid piston-cylinder, or the like. The open/close spring 122 has a spring factor selected so that when the plunger 10 is placed upon the platform 120 in its raised position, the weight of the plunger 10 is greater than the resistive force of the spring 122 to thereby force the platform 120 down to its lowered position (FIG. 2) to charge the spring 122 (and close the shell portions 114, as described below), and when the plunger 10 is removed from the platform 120 (and no other element is loading the spring), the spring 122 discharges to return the platform to its raised position (FIG. 4) and support it there (and open the shell portions 114, as described below).

The couplings of the shell portions 114 to the platform 120 function to transfer motion of the platform 120 to the shell portions 114, and vice versa, to close and open the shell portions 114 upon the plunger 10 being placed upon and removed from, respectively, the platform 120. In the depicted embodiment, for example, the motion-transferring couplings can be pin-and-slot mechanisms each including for example a guide slot 124 in the platform 120 in which a pin 126 of the shell portion 114 slides to cause them to pivot closed when the plunger 10 moves down. The guide slot 124 can be formed directly in the platform 120 or indirectly by being formed in a structure attached to the platform 120. And the pin 126 can be extend directly from the shell portion 114 or indirectly by extending from a structure attached to the shell portion 114. The pin 126 is offset from the pivotal mounting 118 of the shell portion 114 by a fixed dimension, and the guide slot 124 is elongated so that the pin 126 slides within it. In this arrangement, when the platform 120 is moved downward (e.g., under the weight of the plunger 10), the platform guide slot 124 moves downward and drives the shell pin 126 downward, causing the shell pin 126 to ride in the platform guide slot 124 and rotate about the pivotal mount 118 due to the fixed offset dimension, which in turn causes the shell portion 114 to pivot to its open position.

Effectively, this motion-transferring coupling is a motion converter, translating the vertical motion of the platform 120 into pivotal motion of the shell portions 114, and vice versa. And because these parts are coupled and move together, the open/close spring 122 biases the shell portions 114 toward the open position. So (by the reverse process) the shell portions 114 pivot open upon the plunger 10 being lifted up off the platform 120.

In other embodiments, the open/close actuating assembly 106 includes other components and/or other configurations for producing the described functionality. For example, the motion-transferring couplings can each be provided by a gear-set (e.g., rack-and-pinion), a crank-and-link mechanism, a cam-and-follower mechanism, a scissor jack, or another coupling mechanism that transfers motion between the coupled parts of a type know to person of ordinary skill in the art.

The cleaner dispersing assembly 108 includes a plurality of spray nozzles 128 that disperse the cleaner fluid onto the plunger head 14 in the interior space 116 with the shell portions 114 in the closed position. The spray nozzles 128 each include an aperture 130 through which the cleaner is dispersed onto the plunger head 14 and are connected to the pump assembly 110 by fluid lines (not shown). For example, the fluid lines can be provided by flexible tubing that connects to connectors 132 of the spray nozzles 128 and to the pump assembly 110. In typical embodiments, some of the spray nozzles 128 are positioned below the plunger head 14 (e.g., in the base 102) to spray upward into the concave interior of the plunger head (see FIGS. 2 and 4) and other of the spray nozzles 128 are positioned above the plunger head 14 (e.g., in the shell assembly 114) to spray downward onto the convex exterior of the plunger head (see FIGS. 3-4).

The cleaner pump assembly 110 includes a valve mechanism 134 that is operable to pump the cleaner fluid to the cleaner dispersing assembly 108 and an actuator mechanism 136 that is operable to activate the valve mechanism, as best shown in FIGS. 3 and 9-13. The actuator mechanism 136 includes a ram 138 that is biased upward by a spray spring element 140 and that extends downward from a plunger support 142. The ram 138 moves between a raised/normal position (FIG. 3) and a lowered/spray position (FIG. 9). The plunger support 142 is configured for the plunger 10 to rest upon it in stably in an upright position. In the depicted embodiment, for example, the plunger support 142 has an annular upper portion 141 upon which the flange 14 of the plunger head 14 rests and forming a central recessed opening that receives the lower portion of the plunger head extending below the flange, and a central lower portion 143 extending downward from the upper annular portion and from which the ram 138 extends downward.

The spray spring element 140 biases the ram 138 upward to its raised/normal position and is selected with a spring factor such that its resistive force is greater than the weight of the plunger 10, but not so much greater that its resistive force cannot be overcome by a person (e.g., an average adult human) applying a downward force on the plunger 10. As such, when the plunger 10 is resting upon the plunger support 142, the ram 138 is supported by the spray spring 140 in the raised position. And when the plunger 10 is then pushed down with only a relatively moderate force, the plunger support 142 and the ram 138 are moved downward to the lowered position to active the valve mechanism 134 to disperse the cleaner fluid. In the depicted embodiment, the spray spring element 140 is a coil compression spring, though in other embodiments other types of springs can be used such as tension springs, torque springs, an elastically deformable material, a fluid piston-cylinder, or the like.

The cleaner pump assembly 110 is interrelated and coordinated with the open/close actuating assembly 106 in a two-stage sequential arrangement so that resting the plunger 10 on the plunger support 142 closes the shell portions 114 but does not actuate the spray valve 134, and then applying an additional downward force (i.e., in addition to gravity) on the plunger 10 actuates the spray valve 134 to disperse the cleaner onto the plunger head 14. In this way, with the plunger 10 positioned on the plunger support 142 and the shell assembly 104 closed, a user can apply the additional force (e.g., push down on) the plunger 10 and then promptly release the plunger to cause one cleaner-fluid spraying of the plunger head 14, and if desired repeat this in a pumping manner to produce multiple sprayings to sanitize the plunger head.

In the depicted embodiment, the plunger support 142 thus cooperates in both the open/close shell motion and the spray function, and thus is biased upward by both the spray spring 140 (directly) and the open/close spring 122 (indirectly via the platform 120), so the springs are designed to sequence the motions to first close the shell in response to a lesser downward force then spray the cleaner in response to a greater downward force. For example, the spray spring 140 can have a greater spring factor than the open/close spring 122 so that the spray spring does not deform (and thus the plunger support 142 and spray actuator ram 138 do not move down relative to the platform) under the weight of the plunger 10 (i.e., the lesser downward force) (see also FIGS. 7-8), but the open/close spring 122 does deform (and thus the platform 120 does move down relative to the base 102) when the plunger is rested upon the plunger support 142. And with the platform 120 now displaced downward, a greater downward force manually applied to the plunger 10 now compresses the spray spring 140 causing the plunger support 142 and spray actuator ram 138 to move down to activate the valve 134 (see FIGS. 3 and 9). As such, the spray spring 140 biases the plunger support 142 upward relative to and against the platform 120, and the open/close spring 122 biases the platform 120 upward relative to and against the base 102.

In the depicted embodiment, at least one of the spray springs 140 and at least one of the open/close springs 122 are axially aligned with each other, though in other embodiments they can be arranged otherwise for example axially parallel but not axially aligned. In the depicted embodiment, the spray springs 140 and the open/close springs 122 are separate spring elements, though in other embodiments they can be combined into one spring element with a spring factor selected so that the spring deforms only partially under the weight of the plunger so close the shell portions and then can deform further by applying an additional force to activate the spray valve. And in the depicted embodiment, the spray spring 140 biases the plunger support 142 upward relative to the platform 120 and the open/close spring 122 biases the platform 120 upward relative to the base 102, though in other embodiments this arrangement can be switched with the open/close spring positioned above the spray spring and the shell portions coupled to the plunger support.

The valve mechanism 134 can be of a conventional spray-pump type. Referring particularly to FIGS. 9-13, the valve 134 can include for example a piston 144 and a cylinder 146 that reciprocate with respect to each other to produce a fluid-pumping effect, a first piston-cylinder spring 148 biasing them apart, and a second piston-cylinder spring 150 biasing them together and biasing against the actuator ram 138. The valve mechanism 134 additionally includes an intermediate drive or idler member 135 that drives the piston 144 or the cylinder 146 in a compression/actuating stroke and that is driven in an opposite/reverse motion in an expansion/recharging stroke, and that is driven by the ram 138 in the compression/actuating stroke and that drives the ram back up in the expansion/recharging stroke). Also, an outlet connector 152 extends from the valve 134 for connecting the fluid lines 154 running to the spray nozzles 128. The valve mechanism 134 is mounted in to the base 102 and thus does not move with the plunger support 142 and spray ram 138 or with the platform 120. In other embodiments, the valve mechanism can be provided by another fluid pump of a type known by persons of ordinary skill in the art.

In addition, the cleaner pump assembly 110 can include an automatic lock assembly that prevents the spray valve 134 from being operated when the shell assembly 104 is in the open position and that disengages/unlocks regardless of the force/velocity applied (so that actuation of the pump is independent of the downward force or the velocity of the pumping action) to ensure that the spray valve is activated as soon as the lock assembly is disengaged. In the depicted embodiment, for example, the valve-lock assembly includes one or more (e.g., two are depicted) pivotal lock arms 156 a cylinder housing 158, and the idler member 135. The pivotal lock arms 156 engage the cylinder housing 158, which defines the cylinder space 148 of the piston-cylinder spray valve 134, to retain it from moving downward and thus operating the spray valve 134. So with the shell assembly 104 in its open position, if the plunger support 142 and thus the actuator ram 138 was somehow moved downward relative to the platform 120, with the platform remaining in its raised/opened position (e.g., if a foreign objected intruded and caused a jam), the lock arms 156 would prevent operation of the valve 134.

But with the shell assembly 104 in its closed position, the platform 120 has thus been moved to its lowered/closed position. So when the plunger support 142 and thus the actuator ram 138 is moved downward (by the plunger 10 being pushed downward, or otherwise), it engages and drives the idler member 135 from its neutral position (FIGS. 3 and 10), downward into engagement with the lock arms 156 (FIG. 11), and further downward to displace the lock arms 156 from locking engagement with the cylinder housing 158 (FIG. 12). In typical embodiments, the lock arms 156 disengage regardless of force/velocity applied to them by the idler member 135, which ensures reliable unlocking of the spray valve 134 for spraying. The now-unlocked (released) cylinder housing 158 is then propelled, by the second charged piston-cylinder spring 150 discharging its stored spring charge, downward to operate the piston-cylinder valve 134 through a compression stroke to pump spray the cleaner into the closed shell assembly 104 (FIG. 13). At the same time, the downward-moving cylinder housing 158 charges the first piston-cylinder spring 148 (FIGS. 12-13).

After the compression stroke is completed to spray the cleaner onto the plunger 10, the now-charged first piston-cylinder spring 148 discharges to propel the cylinder housing 158 back upward through an expansion stroke and back to its rest/neutral position. At the same time, the upward-moving cylinder housing 158 charges the second piston-cylinder spring 150. When the plunger 10 is released (after being pushed down and then the downward force being removed), the spray spring 140 biases the plunger support 142 and ram 138 back upward to their raised/neutral position away from the idler member 135, so the now-charging second piston-cylinder spring 150 forces the idler member 135 back upward to its raised/neutral position, freeing the lock arms 156 to return to their positions of locking engagement with the cylinder housing 158.

In other embodiments, other lock components and/or configurations can be implemented. For example, the lock member(s) can have another form (e.g., pins, blocks, or decouplers) and/or move through another motion (e.g., linear, rotary, or helical) and/or engage and disengage another part of the pump assembly (e.g., the piston in embodiments with a reciprocating piston instead of cylinder, the idler member, the ram, or the plunger support). Or instead of the lock arms being moved to the unlocked position during operation of the pump mechanism (after the shell actuating mechanism has been operated to close the shell assembly), instead the plunger-cleaning system can be configured to move the lock arms to the unlocked position during operation of the shell actuating mechanism to close the shell assembly and to move them back to the locked position during operation of the shell actuating mechanism to open the shell assembly.

Referring primarily to FIGS. 2 and 14, the cleaner reservoir assembly 112 includes a container 162 that holds the cleaner fluid, is mounted on a cleaner base 164, and is in fluid communication with the valve mechanism 134 by a fluid line (e.g., tubing or an internal passageway) 166. In the depicted embodiment, the cleaner container 162 has a bottom opening and removably attaches to a cleaner base 164 at the bottom opening. For example, the cleaner container 162 and the cleaner base 164 can removably attach together by screw threads 168 so it is very easy to remove the container, refill or replace it, and then reattach it in a clean and hygienic manner. The container 162 can have a screw-off cap (not shown) that can be removed (before installing the container on the base), to expose a resealable silicon sheet that covers the bottom opening of the container 162. As the cleaner container 162 is positioned on its base 164, the silicon cover is punctured by a puncturing tab 170 at the end of the fluid line 166, which allows the disinfectant cleaner solution to enter the fluid line 166. Also, the cleaner base 164 includes an air inlet line 172 with one end at the puncturing tab 172 (so that end is positioned inside an installed container 162) and with the other end exposed to and in communication with ambient air to allow air into the container so that the cleaner fluid will flow as desired.

In the depicted embodiment, the cleaner reservoir assembly 112 is a separate assembly that is attached to the shell base 102, but in other embodiments the cleaner reservoir assembly can be integrated into the shell base, and these can even be integrally formed as one part. And in other embodiments, the cleaner container is fixed to (not removably attached) to the cleaner base, its fluid-outflow opening is positioned at the top of the container (not the bottom), the silicon seal and the puncturing tab are not included, and a removable (e.g., screw-off) cap is included, with the container being refiled by removing the cap, adding fresh disinfectant cleaner fluid, and replacing the cap.

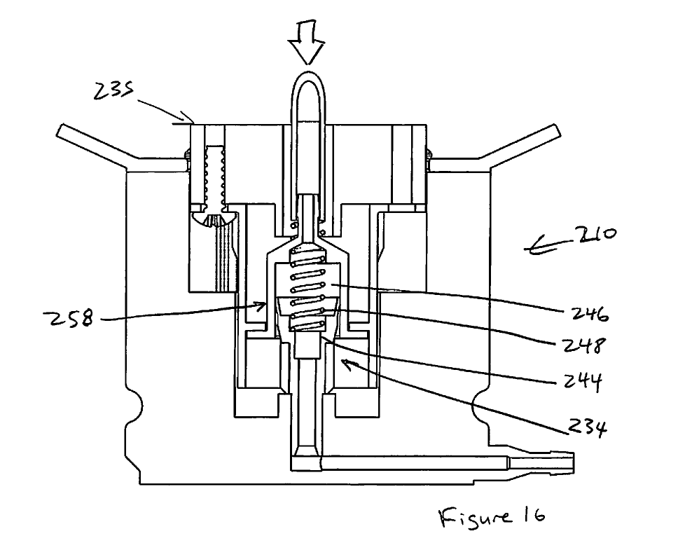

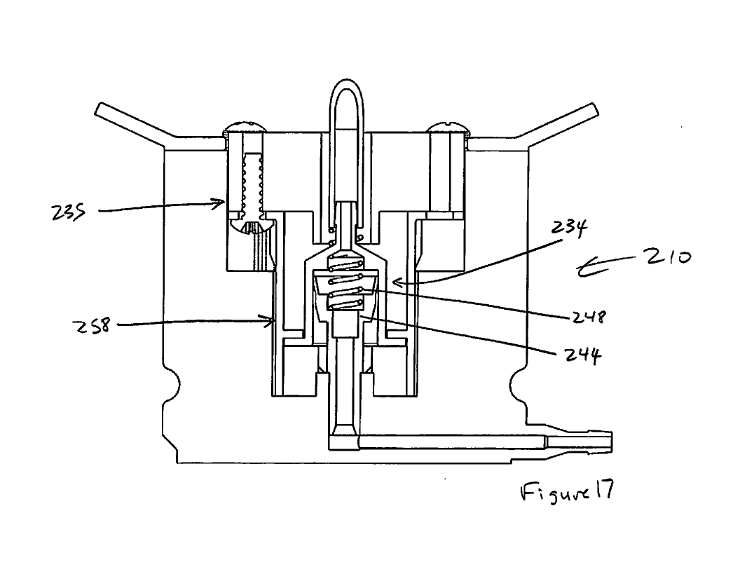

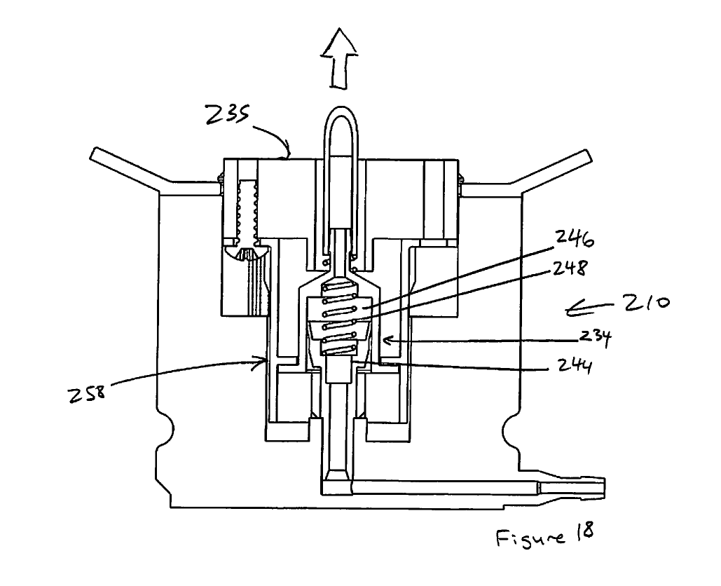

FIGS. 15-18 show a cleaner pump assembly 210 of a plunger-cleaning system according to a second example embodiment of the invention. The cleaner pump assembly 210 is substantially similar to the cleaner pump assembly 110 of the first embodiment. In particular, the cleaner pump assembly 210 of this embodiment includes the same basic components as the first embodiment, with exceptions including the exclusion of the lock assembly and related components. FIGS. 15-17 show the cleaner pump assembly 210 of the second embodiment in various positions along the compression/actuating stroke generally corresponding to the pump positions of FIGS. 10-13 of the first embodiment. And FIG. 18 shows the cleaner pump assembly 210 after completion of the compression/actuating stroke, having pumped the cleaner fluid onto the plunger head, now returning through the expansion/recharging stroke to draw in a fresh charge of the cleaner fluid from the cleaner container so the toilet-plunger cleaning system will be ready for a next use.

As such, the cleaner pump assembly 210 can be directly substituted into the toilet-plunger cleaning system 100 of FIGS. 1-14 or of other cleaning systems adapted for interoperability. Accordingly, a detailed description of the other/remaining components of the toilet-plunger cleaning system will not be repeated for brevity. Further, it should be noted that because the actuator ram extends from and moves with the plunger support, which is spring-biased and coordinated relative to the platform, which is in its raised position when the shell assembly is in its open, the ram is raised and thus spaced apart from the valve engagement element (e.g., the idler member or cylinder housing) when the shell assembly is in its open such that the valve cannot now be actuated (the travel of the ram is not long enough to reach the valve engagement element), and in embodiments with this spacing the lock mechanism can be excluded.

The cleaner pump assembly 210 of this embodiment includes a valve mechanism 234 that is operable to pump the cleaner fluid to the cleaner dispersing assembly (see, e.g., FIGS. 1-14) by operation of the actuator mechanism (see, e.g., FIGS. 1-14). The valve mechanism 234 can be of a conventional spray-pump type for example including a piston 244 and a cylinder 246 that reciprocate with respect to each other to produce a fluid-pumping effect, and a piston-cylinder spring 248 biasing them apart against the actuator ram of the actuator mechanism. The valve mechanism 234 additionally includes an intermediate drive or idler member 235 that is attached to and moves with the cylinder housing 258.

When the additional downward force is applied to the plunger and transferred to the plunger support, the actuator ram of the actuator mechanism drives the idler member 235 and cylinder housing 258 downward relative to the piston 244 in the compression/actuating stroke, which operates the valve to pump the cleaner fluid from the reservoir to the dispersing nozzles and onto the plunger head, and which overcomes the resistive force of the piston-cylinder spring 248 to charge the spring. And when the additional force on the plunger is removed, the now-charged piston-cylinder spring 248 discharges to force the idler member 235 and cylinder housing 258 upward relative to the piston 244 in an opposite/reverse motion in an expansion/recharging stroke to draw in a fresh charge of the cleaner fluid from the cleaner container. Also, an outlet connector 252 extends from the valve 234 for connecting the fluid lines 254 running to the spray nozzles.

Accordingly, the plunger-cleaning systems of various embodiments of the invention provide one or more of the following advantages over other known prior-art devices. Firstly, the plunger-cleaning systems provide a system that is operable to sanitize a used plunger and that is self-contained within a storage system for the plunger. Secondly, the plunger-cleaning systems create no liquid mess during use because the disinfectant is sprayed in a fine mist and/or is evaporative. Thirdly, in order to add more disinfectant to the system, the plunger itself does not need to be handled.

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be limiting of the claimed invention. For example, as used in the specification including the appended claims, the singular forms “a,” “an,” and “one” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

In addition, it should be noted that in some of the drawings, some internal components are excluded to better-show other internal components of the system. For example, FIG. 2 shows the left-side spray spring 140 exposed (with its housing excluded) but the right-side the spray spring is concealed (within its shown housing), and shows the left-side housing for the open/close spring (concealing that spring) but the right-side the open/close spring and housing are excluded. Conversely, FIGS. 3 and 9 show the right-side spray spring 140 exposed (with its housing excluded) but the left-side the spray spring is concealed (within its shown housing), and show the right-side housing for the open/close spring (concealing that spring) but the left-side the open/close spring and housing are excluded. FIG. 4 shows the right-side spray spring 140 exposed (with its housing excluded) but the left-side the spray spring and housing are excluded (to show the spring mounts), and shows the right-side open/close spring 122 exposed (with its housing shown in cross-section) but the left-side the open/close spring excluded (with its housing shown in cross-section, to show the spring mounts). FIGS. 5-6 exclude the cleaner dispersing assembly and the cleaner pump assembly to better-show the open/close actuating assembly 106 for the shell assembly 104. FIG. 2 shows the lower nozzles 128 of the cleaner dispersing assembly but not the upper nozzles, and Figures conversely shows the upper nozzles but not the lower nozzles. And throughout the Figures, the fluid lines 166 and 154 for the cleaner fluid (from the reservoir 162 to the valve 134 and from the valve to the nozzles 128, respectively) are not shown in their entirely, but based on the identified parts that are connected (and the identified connectors), persons of ordinary skill in the art will understand the intended fluid communication between the identified parts.

While the invention has been shown and described in exemplary forms, it will be apparent to those skilled in the art that many modifications, additions, and deletions can be made therein without departing from the spirit and scope of the invention as defined by the following claims.

What is claimed is:

1. A system for cleaning a toilet plunger with a cleaner, the cleaning system comprising:
an open/close shell assembly that includes at least one shell portion that moves between an open position and a closed position and in the closed position defines an interior space, wherein in the open position a head of the plunger can be inserted into and removed from the interior space, and wherein in the closed position the plunger head is substantially enclosed within the interior space;
a plunger support that supports the plunger, with the plunger head in the shell assembly interior space, when the shell assembly is in the closed position;
an open/close actuating assembly that is operable to move the shell portions between the open and closed positions;
a cleaner reservoir assembly including a container that holds the cleaner;
a cleaner dispersing assembly including at least one spray nozzle that disperses the cleaner onto the plunger head in the interior space with the shell portions in the closed position; and
a cleaner pump assembly including a valve mechanism and an actuator mechanism, wherein the valve mechanism is in fluid communication with, and is operable to pump the cleaner between, the cleaner container and the spray nozzle, and wherein the actuator mechanism is operable to activate the valve mechanism.

2. The plunger-cleaning system of claim 1, wherein upon placing the plunger on the plunger support with the shell assembly in the open position, the weight force of the plunger activates the actuating assembly to reconfigure the shell assembly to the closed position.

3. The plunger-cleaning system of claim 2, wherein upon placing the plunger on the plunger support with the shell assembly in the open position, the weight force of the plunger is insufficient to activate the cleaner pump assembly.

4. The plunger-cleaning system of claim 3, wherein applying an additional force to the plunger resting on the plunger support activates the cleaner pump assembly to deliver the cleaner fluid from the cleaner reservoir assembly through the cleaner dispersing assembly and onto the plunger head in the closed shell assembly.

5. The plunger-cleaning system of claim 1, wherein the open/close shell assembly, the plunger support, the open/close actuating assembly, the cleaner reservoir assembly, the cleaner dispersing assembly, and the cleaner pump assembly are configured for providing a two-stage sequential operation to first close the shell assembly upon resting the plunger on the plunger support such that the weight force of the plunger activates the open/close actuating assembly to reposition the open/close shell assembly from an open position to a closed position with the plunger head within the open/close shell assembly, but the weight force of the plunger on the plunger support does not activate the cleaner pump assembly, and then second to spray the cleaner from the cleaner reservoir assembly to the cleaner dispersing assembly and onto the plunger head upon applying an additional force to the plunger such that the additional force activates the cleaner pump assembly.

6. The plunger-cleaning system of claim 1, further including a base to which the at least one shell portion is movably mounted and which houses the cleaner pump assembly.

7. The plunger-cleaning system of claim 1, wherein the at least one shell portion of the open/close shell assembly is spring-biased open, and wherein the open/close actuating assembly includes a spring-biased platform that moves from a raised position downward to a lowered position under the weight force of the plunger when the plunger is placed upon the plunger support and that is mounted by a motion-transferring coupling to the at least one shell portion to cause the shell portion to move to the closed position when the platform moves to the lowered position.

8. The plunger-cleaning system of claim 7, wherein the platform is spring-biased to the raised position by an open/close spring that has a spring factor selected to provide less resistive force than the weight force of the plunger.

9. The plunger-cleaning system of claim 7, wherein the motion-transferring coupling is provided by a pin-and-slot mechanism that pivotally mounts the at least one shell portion to the platform.

10. The plunger-cleaning system of claim 7, wherein by a reverse operation the shell portion returns to the open position upon the plunger being removed from the plunger support.

11. The plunger-cleaning system of claim 7, wherein the actuator mechanism of the cleaner pump assembly includes an actuator ram that extends downward from the plunger support, that is spring-biased upward by a spray spring, and that moves from a raised position downward to a lowered position when the plunger rests on the plunger support and an additional force is applied to the plunger, after the platform has been displaced down to its lowered position to close the shell portion, to activate the valve mechanism to disperse the cleaner into the interior space.

12. The plunger-cleaning system of claim 11, wherein the spray spring is selected with a spring factor having a resistive force that is less than the additional force, which is in addition to the weight force of the plunger.

13. The plunger-cleaning system of claim 11, wherein the spray spring raises the actuator ram and the plunger support back up to the raised position upon removal of the additional force from the plunger.

14. The plunger-cleaning system of claim 1, wherein the at least one spray nozzle is provided by at least one spray nozzle positioned below the plunger head on the plunger support in the shell assembly to spray upward into the plunger head and at least one spray nozzles positioned above the plunger head on the plunger support in the shell assembly to spray downward onto the plunger head.

15. The plunger-cleaning system of claim 1, further comprising a lock assembly including at least one movable lock member that engages and locks a moving element of the valve mechanism to retain it from moving to activate the valve mechanism when the shell portion is in the open position, but that is disengaged and unlocked from the moving element of the valve mechanism to permit it to move to activate the valve mechanism when the shell portion is in the closed position.

16. The plunger-cleaning system of claim 15, further comprising at least one idler member that is driven by the actuator mechanism to contact and displace the lock member from locking engagement with the moving element of the valve mechanism when the shell portion is in the closed position but that is not so drive when the shell portion is in the open position.

17. A system for cleaning a toilet plunger with a cleaner, the cleaning system comprising an open/close shell assembly, an open/close actuating assembly, a cleaner dispersing assembly, a cleaner pump assembly, a cleaner reservoir assembly, and a plunger support, configured for providing a two-stage sequential operation to first close the shell assembly upon resting the plunger on the plunger support such that the weight force of the plunger activates the open/close actuating assembly to reposition the open/close shell assembly from an open position to a closed position with a head of the plunger within the open/close shell assembly, but the weight force of the plunger on the plunger support does not activate the cleaner pump assembly, and then second to spray the cleaner from the cleaner reservoir assembly to the cleaner dispersing assembly and onto the plunger head upon applying an additional force to the plunger such that the additional force activates the cleaner pump assembly.

18. The plunger-cleaning system of claim 17, wherein the plunger support is biased upward by an open/close spring of the open/close actuating assembly and by a spray spring of the cleaner pump assembly, wherein the spray spring has a greater spring factor than the open/close spring.

19. The plunger-cleaning system of claim 18, wherein the spray spring does not deform, and thus the cleaner pump assembly is not activated, under the weight force of the plunger resting on the plunger support, but the open/close spring does deform, and thus the open/close actuating assembly is activated, under the weight force of the plunger resting on the plunger support.

20. The plunger-cleaning system of claim 19, wherein the spray spring does deform, and thus the cleaner pump assembly is activated, under the additional force being applied to the plunger resting on the plunger support, wherein the additional force is in addition to the weight force of the plunger.
